(19) United States
(12) Patent Application Publication
(10) Pub. No.: US 2008/0260592 A1
(43) Pub. Date: Oct. 23, 2008

(54) Discretely Adjustable Pipettor

(76) Inventors: Zhenggang Yang, New York, NY (US); Ge Yang, Taian (CN)

Correspondence Address: CHIA-YU-CHANG, 315 W. 70TH STREET, #12L, NEW YORK, NY, 10023, US

(21) Appl. No.: 12/029,646

(22) Filed: Feb. 12, 2008

(30) Foreign Application Priority Data
Apr. 23, 2007 (CN) 200720021038.2

(51) Int. Cl. B01L 3/02

(52) U.S. Cl. 422/100

(57) ABSTRACT

A pipettor is provided of discretely adjusting the volume of fluid transferable by the pipettor in a pipetting operation. One or multiple piston assemblies, comprising pistons detached from the actuator of the pipettor, resilient members that urges the pistons toward initial positions, and independent adjusting mechanisms, such as slide-and-lock, facilitate discrete adjustments of the pipetting volume. The pipettor affords the operator to expediently adjust the pipetting volume, and to conveniently operate the pipettor using only one hand.

### BACKGROUND

This invention relates to pipettors having adjustable control over the volume of fluid transferable via the pipettors.

Pipettors, also referred to as pipettes, are used widely to transfer minute amounts of fluid for sampling or adjustment purposes in industries such as biology, chemistry, or chemical engineering. A pre-set amount of fluid is drawn from a host holding container or device into the pipettor by utilizing the movement of a piston; carried in the pipettor to a target destination; and then dispensed from the pipettor into a destination holding container or device. More specifically, the pipettor typically comprises a piston slidably inserted into a fluid chamber, which is tightly sealed, except for a tip opening communicating with the external space. The operator actuates the movement of the piston by, for example, pushing a plunger, which engages and moves the piston. In response to the actuation force, the piston body moves and enters into the fluid chamber, expelling through the tip opening a volume of air equal to the volume of the piston body entering the fluid chamber. The operator then actuates the piston to withdraw it out of the fluid chamber by, for example, releasing the plunger. The withdrawal of the piston results in a vacuum condition inside the fluid chamber, and forcing the outside fluid to be aspirated into the fluid chamber through the small opening.

The amount of fluid that can be drawn into the fluid chamber depends on the volume of the piston entering the fluid chamber, and is traditionally adjustable by using a threaded screw. The operator uses the screw to gradually change the beginning position of the piston, which in turn changes the volume of fluid that may be drawn into and stored in the pipettor.

### SUMMARY

Traditional pipettors afford a user to adjust the volume of fluid transferred and dispensed to high precisions. They, however, may require the user to spend a long period of time rotating the screw to make adjustments between successive uses, particularly if the required adjustments are large. Furthermore, rotating the screw normally requires the operator to use both hands, while it is often convenient and desirable in the laboratory to hold the pipettor in one hand and to leave the other hand available to hold another apparatus or for other purposes.

The present invention resolves these shortcomings by allowing users to discretely adjust the fluid volume transferable via the pipettor, thereby permitting the user to operate the pipettor conveniently with one hand and reducing the time required to make adjustments, without significantly sacrificing the precision.

In general, in a first aspect, the invention features a discretely adjustable pipettor that includes an elongated housing chamber, a middle buffer, an elongated fluid chamber, an elongated actuator, an actuator resilient member, and one or multiple adjustable piston assembly. The housing chamber has an upper end and a lower end, and is connected in its lower end to one end of the middle buffer. The middle buffer is in turn connected in the other end to the fluid chamber, with the length of the fluid chamber aligned along the same axis as that of the housing chamber. One or more tunnel openings on the middle buffer interconnect the interiors of the housing chamber and the fluid chamber. The distal end of the fluid chamber narrows into a tip opening. The actuator is inserted partially into the housing chamber through a principal opening on the upper end of the housing chamber. An actuator resilient member is configured in such a way that it urges the actuator away from the fluid chamber. Each of the one or multiple piston assembly further includes an elongated piston, a piston resilient member, and means for discretely adjusting the piston engaging position. The piston is positioned slidably through one of the tunnel openings on the middle buffer, with its axis aligned along that of the housing chamber, having one end pointing toward the actuator and the other end pointing toward the fluid chamber. The end of the piston more proximate to the actuator is not connected to the actuator but may make contact with the actuator at an engaging position, which may be adjusted discretely by the means for discretely adjusting the piston engaging position.

Embodiments of the invention may include one or more of the following features. In one embodiment, the means for discretely adjusting the piston engaging position may be a slide-and-lock mechanism, including an elongated sliding aperture on the wall of the housing chamber, an adjusting handle, and means for locking the adjusting handle. The sliding aperture runs parallel to the axis of the housing chamber, having one end closer to the actuator than the other. The adjusting handle is partially inserted through the sliding aperture, with an internal end inside the housing chamber and an external end outside the housing chamber. The external end of the adjusting handle facilitates the user to slide and move the adjusting handle along the sliding aperture, and lock the adjusting handle at a fixed position via the means for locking the adjusting handle. The internal end of the adjusting handle are positioned such that it restricts the piston from moving beyond the fixed position of the adjusting handle and engages and moves the piston along as the adjusting handle travels along the sliding aperture toward the fluid chamber.

In another embodiment, the means for locking the adjusting handle may include a set of locking apertures and a resilient member attached to the adjusting handle. The locking apertures are individually connected to the sliding aperture with an angle, and spread along the length of the sliding aperture. The resilient member, such as a spring or a V-clip, is attached to one side of the adjusting handle and configured to lock the external end of the adjusting handle into one of the locking apertures, preventing the adjusting handle from continuing to reciprocate along the sliding aperture.

In another embodiment, the piston resilient member may be a spring wrapped around the piston, with one end attached to the middle buffer wall, and the other end to the end of piston away from the lower end of the housing chamber.

In another embodiment, the actuator resilient member may be a spring wrapped around the portion of the actuator within the housing chamber, with one end attached to the end of the actuator inside the housing chamber, and the other end to the wall collars of the principal opening on the upper end of the housing chamber.

In another embodiment, the number of piston assemblies may be three, and the pistons may be calibrated to expel up to 10 μl, 100 μl, and 1000 μl fluid-equivalent of air, adjustable by 1 μl, 10 μl, and 100 μl intervals, respectively.

In another embodiment, the actuator may be a hollow shell fitted onto an elongated supporting beam. The supporting beam runs parallel to the length of the pipettor, with one end fixed to the lower end of the housing chamber and the other end extending sufficiently far toward the opposite direction to support the actuator shell. A resilient member, such as a spring, may be configured to urge the actuator shell away from the middle buffer.

In another embodiment, the housing chamber may additionally include a base ring disk fixed to the internal wall of the housing chamber along a cross-sectional circumference located between the upper end of the housing chamber and the end of the sliding aperture close to the actuator. A sliding rod oriented along the axis of the pipettor body is bored slidably through the adjusting handle, with one end fixed to the base ring disk and the other end fixed to the middle buffer.

In another embodiment, the piston resilient member may be a spring wrapped around the piston and additional elements are added, including a piston cover that is wrapped around the piston, with one end fixed to the lower end of the housing chamber and the other end connected to one end of the piston spring. Also included is a spring cover that is wrapped around the piston spring, with one end fixed to the end of the piston closer to the actuator. The spring cover moves in tandem with the piston.

### BRIEF DESCRIPTION OF THE DRAWINGS

FIG. 1 shows a partially perspective side view of the pipettor body.

FIG. 2 shows a cross-sectional view of the pipettor along line A-A′ in FIG. 1.

FIG. 3 shows a cross-sectional view of the pipettor along line B-B′ in FIG. 1.

### DETAILED DESCRIPTION

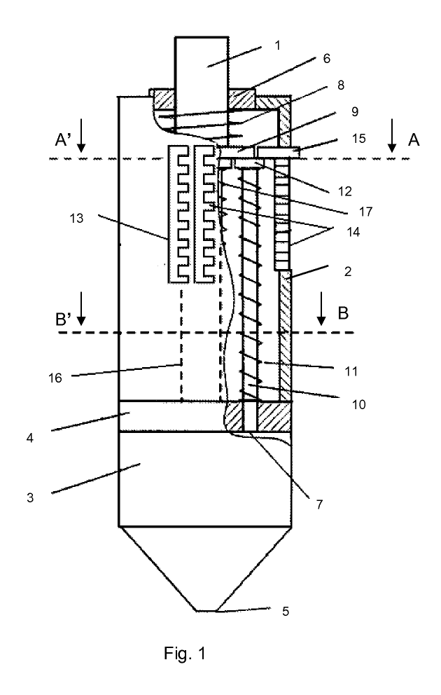

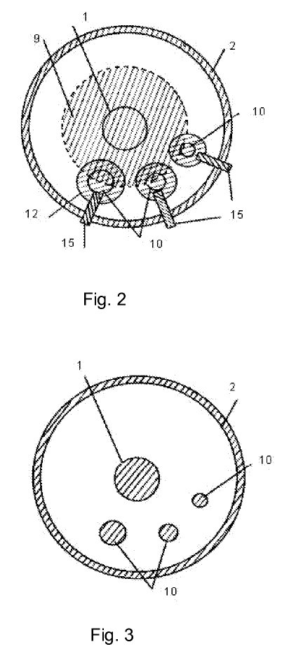

In general, this disclosure provides apparatuses for discretely adjusting the volume of fluid aspirated and dispensed in a pipetting operation. Referring to FIGS. 1-3, the disclosed pipettor generally comprises an elongated housing chamber 2 that has a upper end and a lower end and holds the bulk of the components. The upper end of the housing chamber 2 has a principal opening 6, and an elongated actuator 1 is partially inserted through the opening into the housing chamber 2, leaving an actuator external end outside of the housing chamber 2 and an internal end inside 9 the housing chamber 2, and allowing the actuator 1 to slide axially inside the housing chamber 2 in response to forces applied on the external end of the actuator 1. The actuator 1 further comprises a resilient member 8 that is configured to assert a biasing force on the actuator 1 toward the housing chamber actuator opening 6. The lower end of the housing chamber 2 is connected to a middle buffer 4, which is connected on the opposite side with an elongated fluid chamber 3. The middle buffer has one or multiple tunnel openings 7 interconnecting the interiors of the housing chamber and the fluid chamber. The fluid chamber 3 extends lengthwise along the axis of the housing chamber 2, and narrows toward the distal end and concludes with a tip opening 5, through which fluid is drawn into and dispensed from the fluid chamber 3.

One or multiple piston assembly is installed inside the housing chamber 2, the number of piston assemblies equal to the number of tunnel openings 7 on the middle buffer 4. Each piston assembly comprises an elongated piston 10 aligned longitudinally with the housing chamber 2. One end of the piston 10 is inserted through one of the tunnel openings 7 on the middle buffer 4, allowing the piston 10 to slide lengthwise between the housing chamber 2 and the fluid chamber 3. The other end of the piston 10 points toward the actuator 1 and concludes with a stopper 12, which is not connected to nor overlaps with the actuator 1. The piston stopper end 10 is restricted from moving beyond a fixed stop point in the direction toward the actuator 1. This fixed stop point may be implemented and adjusted independently for each individual piston assembly by mechanisms and devices known to the arts, some of them described in this present disclosure. Furthermore, each piston assembly comprises a resilient member 11 that is configured to assert a biasing force on the piston 10 toward the actuator 1. As the actuator 1 moves in the direction of the fluid chamber 3 to the fixed stop point of the piston 10, the actuator internal end 9 makes contact with the piston stopper end 12, and engages the piston 10 to move it together in tandem.

If multiple piston assemblies are present, the pistons 10 of the multiple piston assemblies may possess similar length but different cross-section areas, representing different unit volumes. Moreover, the tunnel openings 7 on the middle buffer 4 are properly sealed and lubricated, allowing vacuum conditions to exist in the fluid chamber 3 and the pistons 10 to slide frictionlessly through the tunnel openings 7.

In embodiment #1, the pipettor comprises one single piston assembly, and the fixed stop point of the piston 10 is adjustably controlled by a slide-and-lock mechanism, including a sliding aperture 13 on the wall of the housing chamber 2, a set of multiple locking apertures 14, and an adjusting handle 15. The length of the sliding aperture 13 runs parallel to the axis of the pipettor body, beginning from a point close to the actuator 1 and extending toward the fluid chamber 3. The set of multiple locking apertures 14 are connected with and spread along the length of the sliding aperture 13, and oriented angularly to the axis of the sliding aperture 13. The adjusting handle 15 is partially inserted through the sliding aperture 13 into the housing chamber 2, leaving an external end outside the housing chamber 2 and an internal end inside the housing chamber, and may slide within the confine of the sliding aperture 13 along the aperture's length. As the adjusting handle 15 slides along the sliding aperture 13, its internal end engages the piston stopper end 12 and moves the piston 10 along. Furthermore, the adjusting handle 15 can be fixed and locked into one of the locking apertures 14, thus restricting the piston 10 from moving beyond the adjusting handle 15 toward the actuator 1, and thereby setting up the fixed stop point.

As an illustration of a typical operation of this embodiment, the operator first moves the adjusting handle 15 off the locked position initially set at the first locking aperture 14 counting from the actuator 1. Under this configuration, the side panel of the adjusting handle 15 facing the fluid chamber 3 is in contact with the piston stopper end 12. The operator then slides the adjusting handle 15 along the sliding aperture 14 toward the fluid chamber 3, pushing the piston 10 and moving it along. As the piston 10 moves further toward the fluid chamber 3, the resilient member 11 asserts increasing biasing force on the piston 10 against the forward movement. The operator then locks the adjusting handle 15 into a locking aperture 14 halfway along the sliding aperture length. The internal portion of the adjusting handle 15 continues to stay in contact with the piston stopper end 12, preventing the piston 10 from moving further toward the actuator 1 under influence of the biasing force asserted on the piston 10 by the piston resilient member 11. Under this configuration, the maximum volume of the piston body retained inside the housing chamber 2 is reduced according to the new locked position of the adjusting handle 15. Additionally, a spatial gap is created between the actuator internal end 9 and the piston stopper end 12.

The operator then applies pressure on the actuator 1 to move it toward the fluid chamber 3, against the opposing biasing force asserted by the actuator resilient member 8. After traveling the spatial gap created earlier between the actuator internal end 9 and the piston stopper end 12, the actuator internal end 9 makes contact with the piston stopper end 12, engages it, and moves the piston along toward the fluid chamber 3, until the piston 10 can no longer move any further. Under such a configuration, the piston body previously inside the housing chamber 2 has entered the fluid chamber 3 to the maximum extent, expelling an equivalent volume of air out of the fluid chamber 3.

Continuing applying pressure on the actuator 1 and holding the piston 10 steady, the operator then immerses the tip opening 5 of the fluid chamber 3 in the fluid stored in a host container, and gradually removes the pressure on the actuator 1. The biasing force asserted by the actuator resilient member 6 then moves the actuator 1 back away from the fluid chamber 3. Freed from the pressure asserted by the actuator 1, the piston 10 also moves away from the fluid chamber 3 in response to the biasing force asserted by the piston resilient member 11. The withdrawal of the piston 10 from the fluid chamber 3 reduces the air pressure inside the fluid chamber 3, creating a vacuum condition that in turn aspirates an equivalent amount of fluid into the fluid chamber 3. The operator may then move the pipettor to a target destination and again apply pressure on the actuator 1 to move it, and thereby the piston, toward the fluid chamber to dispense the fluid previously aspirated into the fluid chamber 3.

In embodiment #2, the number of piston assemblies is increased to three. Each piston 10 of the three piston assemblies has varying cross-sectional areas, resulting in varying but known unit volumes of the piston bodies 10. As an illustration, the three pistons 10 respectively may displace 0-10 μl, 0-100 μl, and 0-1000 μl equivalent of fluid, meaning if the fixed stop points of the three pistons 10 are set at their respective first locking apertures counting from the actuator end of the sliding aperture 13, the full amount of fluid dispensable by the pipettor is 1110 μl. Furthermore, each of the piston assembly comprises eleven locking apertures 14 evenly spaced along the sliding aperture 13, resulting in ten adjustment notches. Moving the adjusting handle 15 by one notch hence represents changes in fluid volume of 1 μl, 10 μl, and 100 μl, respectively. If the operator desires to transfer, for example, 867 μl, of fluid, she may first move the 1000 μl adjusting handle two notches to the third locking aperture, then move the 100 μl adjusting handle four notches to the fifth locking aperture, and finally move the 10 μl adjusting handle three notches to the fourth locking aperture. Under this configuration, when the operator moves the actuator 1 toward the fluid chamber 3, the actuator internal end 9 will first contact and engage the 1000 μl piston and push it along. As the actuator continues to travel forward, it will then engage the 10 μl piston, followed by the 100 μl piston. When the actuator 1 movement is finally stopped by the middle buffer 4, a total of 867 μl of air has been expelled from the fluid chamber 3, allowing an equivalent amount of fluid to fill in the vacuum void created when the pistons 10 subsequently withdraw from the fluid chamber 2.

In embodiment #3, a resilient member, such as a spring or a v-shaped clip, is attached to one side of the adjusting handle 15. The resilient member fixes and locks the adjusting member into the desired locking aperture.

In embodiment #4, the piston resilient member 11 is a spring wrapped around the piston 10, with one end attached to the middle buffer 4 and the opposite end attached to the piston stopper end 12.

In embodiment #5, the actuator resilient member 6 is a spring wrapped around the portion of the actuator 1 inside the housing chamber 2, with one end attached to the actuator internal end 9, and the opposite end attached to the housing chamber wall collar of the actuator opening 6.

In embodiment #6, the actuator 1 has a hollow interior, with an external shell. The actuator shell is fitted onto an elongated supporting beam 16 which runs parallel to the length of the pipettor, with one end fixed to the middle buffer 4, and the other end extending sufficiently far toward the housing chamber actuator opening 6 to support the actuator shell. The supporting beam may include a resilient member 17, such as a spring wrapped around the beam body, configured to assert a biasing force on the actuator shell to move away from the fluid chamber 3.

In embodiment #7, additional elements are added, including a base ring disk attached to the internal wall of the housing chamber 2 along a cross-sectional circumference between the upper end of the housing chamber 2 and the actuator end of the sliding aperture 13. An elongated sliding rod running parallel to the axis of the housing chamber 2 is next inserted vertically into the adjusting handle 15, with one end fixed to the base ring disk and the other end fixed to the middle buffer 4. The adjusting handle 15 may slide on the sliding rod.

In embodiment #8, the piston resilient member 11 is a spring wrapped around the piston and additional elements are added, including a piston cover that is wrapped around the piston 10, with one end fixed to the middle buffer 4 and the other end connected with the piston spring 11. Also included is a spring cover that is wrapped around the piston spring 11, with one end fixed to the piston stopper end 12, and the other end wrapped around the piston cover. The spring cover moves in tandem with the piston 10.

We claim:

1. a discretely adjustable pipettor, comprising:
i. an elongated housing chamber having a upper end and a lower end, said upper end having a principal opening having wall collars and said lower end having one or more openings;
ii. a middle buffer having a first end and a second end, and one or multiple tunnels running through the middle buffer mass and having associated openings on said first and second ends, said first end connected to the housing chamber lower end, matching said middle buffer first end openings with the openings on the housing chamber lower end;
iii. an elongated fluid chamber having a proximate end and a distal end, said proximate end having one or multiple openings and connected to the middle buffer second end, matching said fluid chamber proximate end openings with the openings on the middle buffer second end, and said distal end having a tip opening;
iv. an elongated actuator positioned slidably through the housing chamber upper end opening along the axis of the housing chamber, having an internal end inside the housing chamber and an external end outside the housing chamber;
v. an actuator resilient member configured to urge the actuator away from the fluid chamber;
vi. one or more adjustable piston assembly, each comprising:
a. an elongated piston positioned longitudinally in the housing chamber and having stopper and buffer ends, said stopper end contacting but not fixed to the actuator internal end at an adjustable engaging position, and said buffer end positioned slidably through one of the middle buffer tunnels;
b. a piston resilient member configured to urge the piston against the direction of the fluid chamber;
c. means for discretely adjusting the piston engaging position.

2. the discretely adjustable pipettor in claim 1, wherein the means for discretely adjusting the piston engaging position further comprises:
i. an elongated sliding aperture running parallel to the axis of the housing chamber on the wall of the housing chamber, having an first end and a second end, said first end being more proximate to the actuator than said second end;
ii. an adjusting handle positioned slidably through the sliding aperture and having an external end exposed outside of the housing chamber and an internal end inside the housing chamber, said adjusting handle internal end positioned to restrict the piston stopper end from moving further in the direction toward the housing chamber upper end, and to engage the piston and move it toward the fluid chamber;
iii. means for locking the adjusting handle at a position along the length of the sliding aperture.

3. the discretely adjustable pipettor in claim 2, wherein the piston resilient member is a spring wrapped around the piston, having one end attached to the housing chamber lower end, and the other end attached to the piston stopper end.

4. the discretely adjustable pipettor in claim 2, wherein the actuator resilient member is a spring wrapped around the portion of the actuator within the housing chamber, having one end attached to the actuator internal end and the other attached to the housing chamber actuator opening wall collars.

5. the discretely adjustable pipettor in claim 4, wherein the piston resilient member is a spring wrapped around the piston, having one end attached to the housing chamber lower end, and the other end attached to the piston stopper end.

6. the discretely adjustable pipettor in claim 5, wherein the number of piston assemblies is three (3), and the pistons are calibrated to expel up to 10 μl, 100 μl, and 1000 μl fluid-equivalent of air, adjustable by 1 μl, 10 μl, and 100 μl intervals respectively.

7. the discretely adjustable pipettor in claim 6, wherein the adjusting handle resilient member is a spring.

8. the discretely adjustable pipettor in claim 6, wherein the adjusting handle resilient member is a V-clip.

9. the discretely adjustable pipettor in claim 7, wherein the actuator is a hollow shell fitted onto an elongated supporting beam, said supporting beam running parallel to the length of the pipettor, with one end fixed to the middle buffer, and the other end extending sufficiently far toward the housing chamber upper end to support the actuator shell, and further comprises a resilient member configured to assert a biasing force on the actuator shell to move away from the fluid chamber.

10. the discretely adjustable pipettor in claim 2, wherein each of the one or multiple piston assembly additionally comprises:
i. a piston cover wrapped around the piston, having one end fixed to the housing chamber lower end and the other end connected to an end of the piston spring;
ii. a spring cover wrapped around the piston spring, having one end fixed to the piston stopper end, and the other end wrapped reciprocatorily around the piston cover.

11. the discretely adjustable pipettor in claim 2, wherein the means for locking the adjusting handle at a position along the length of the sliding aperture further comprises:
i. a plurality of locking apertures positioned along the length of the sliding aperture, connected with the sliding aperture, and oriented angularly to the axis of the sliding aperture;
ii. a resilient member attached to one side of the adjusting handle and configured to lock the adjusting handle external end into one of the locking apertures.

12. the discretely adjustable pipettor in claim 11, wherein the piston resilient member is a spring wrapped around the piston, having one end attached to the housing chamber lower end, and the other end attached to the piston stopper end.

13. the discretely adjustable pipettor in claim 11, wherein the actuator resilient member is a spring wrapped around the portion of the actuator within the housing chamber, having one end attached to the actuator internal end and the other attached to the housing chamber actuator opening wall collars.

14. the discretely adjustable pipettor in claim 13, wherein the piston resilient member is a spring wrapped around the piston, having one end attached to the housing chamber lower end, and the other end attached to the piston stopper end.

15. the discretely adjustable pipettor in claim 14, wherein the number of piston assemblies is three (3), and the pistons are calibrated to expel up to 10 μl, 100 μl, and 1000 μl fluid-equivalent of air, adjustable by 1 μl, 10 μl, and 100 μl intervals respectively.

16. the discretely adjustable pipettor in claim 15, wherein the adjusting handle resilient member is a spring.

17. the discretely adjustable pipettor in claim 15, wherein the adjusting handle resilient member is a V-clip.

18. the discretely adjustable pipettor in claim 16, wherein the actuator is a hollow shell fitted onto an elongated supporting beam, said supporting beam running parallel to the length of the pipettor, with one end fixed to the middle buffer, and the other end extending sufficiently far toward the housing chamber upper end to support the actuator shell, and further comprises a resilient member configured to assert a biasing force on the actuator shell to move away from the fluid chamber.

19. the discretely adjustable pipettor in claim 16, wherein the housing chamber additional comprises:
i. a base ring disk fixed to the internal wall of the housing chamber along a cross-sectional circumference between the housing chamber upper end and the sliding aperture first end;
ii. a sliding rod oriented longitudinally, having one end fixed to the base ring disk and the other end fixed to the housing chamber lower end, and boring slidably through the adjusting handle.
